(19) United States
(12) Patent Application Publication
(10) Pub. No.: US 2016/0023557 A1
(43) Pub. Date: Jan. 28, 2016

(54) DEVICES, SYSTEMS, AND METHOD FOR DYNAMIC ELECTRIC VEHICLE CHARGING WITH POSITION DETECTION

(71) Applicant: QUALCOMM Incorporated, San Diego, CA (US)

(72) Inventors: Bernward Dimke, Munich (DE); Simon Grabar, Munich (DE); Nicholas Athol Keeling, Auckland (NZ)

(21) Appl. No.: 14/341,672

(22) Filed: Jul. 25, 2014

(51) Int. Cl. B60L 11/18; H02J 7/00; H02J 7/02

(52) U.S. Cl. CPC B60L 11/182; H02J 7/025; H02J 7/0047; H02J 7/007; B60L 11/1824

(57) ABSTRACT

Systems, methods, and apparatus are disclosed for wirelessly charging an electric vehicle. In one aspect, a method of wirelessly charging an electric vehicle is disclosed. The method includes generating a wireless field at a power level sufficient to charge the electric vehicle by at least one charging circuit comprising at least one coil. The method further includes detecting an arrival of the electric vehicle at the at least one charging circuit, the detection of the arrival of the electric vehicle determined based on a level of current flowing through the at least one coil. The method further includes generating a proximity signal upon the detection of the arrival of the electric vehicle at the at least one charging circuit.

### TECHNICAL FIELD

This application is generally related to wireless power charging of chargeable devices such as electric vehicles.

### BACKGROUND

Chargeable systems, such as vehicles, have been introduced that include locomotion power derived from electricity received from an energy storage device such as a battery. For example, hybrid electric vehicles include on-board chargers that use power from vehicle braking and traditional motors to charge the vehicles. Vehicles that are solely electric generally receive the electricity for charging the batteries from other sources. Battery electric vehicles are often proposed to be charged through some type of wired alternating current (AC) such as household or commercial AC supply sources. The wired charging connections require cables or other similar connectors that are physically connected to a power supply. Cables and similar connectors may sometimes be inconvenient or cumbersome and have other drawbacks. It is desirable to provide wireless charging systems that are capable of transferring power in free space (e.g., via a wireless field) to be used to charge the electric vehicle to overcome some of the deficiencies of wired charging solutions.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the subject matter described herein describes an apparatus for wirelessly charging an electric vehicle. The apparatus includes at least one charging circuit configured to generate a wireless field at a power level sufficient to charge the electric vehicle. The apparatus further includes at least one proximity device configured to generate a proximity signal upon detecting an arrival of the electric vehicle at the at least one charging circuit. The detecting of the arrival is based at least in part on detecting a change in an electrical characteristic of the charging circuit. The change is based on a change in distance of the electric vehicle from the charging circuit. The apparatus further includes a processor configured to generate a signal controlling an activation or deactivation of the at least one charging circuit in response to receiving the proximity signal from the at least one proximity device.

Another aspect of the subject matter described herein describes a method of wirelessly charging an electric vehicle. The method includes generating a wireless field at a power level sufficient to charge the electric vehicle by at least one charging circuit. The method further includes detecting an arrival of the electric vehicle at the at least one charging circuit, the detecting of the arrival of the electric vehicle based at least in part on detecting a change in an electrical characteristic of the charging circuit, the change based on a change in distance of the electric vehicle from the charging circuit. The method further includes generating a signal controlling an activation or deactivation of the at least one charging circuit based at least in part on the detection of the arrival of the electric vehicle at the at least one charging circuit.

Another aspect of the subject matter described herein describes an apparatus for wirelessly charging an electric vehicle. The apparatus includes means for generating a wireless field at a power level sufficient to charge the electric vehicle. The apparatus further includes means for detecting an arrival of the electric vehicle at the means for generating a wireless field, the detecting of the arrival of the electric vehicle based at least in part on detecting a change in an electrical characteristic of the means for generating a wireless field, the change based on a change in distance of the electric vehicle from the means for generating a wireless field. The apparatus further includes means for generating a signal controlling an activation or deactivation of the means for generating a wireless field based at least in part on the detection of the arrival of the electric vehicle at the means for generating a wireless field.

### BRIEF DESCRIPTION OF THE DRAWINGS

FIG. 1 is a functional block diagram of a wireless power transfer system, in accordance with one exemplary implementation.

FIG. 2 is a functional block diagram of a wireless power transfer system, in accordance with another exemplary implementation.

FIG. 3 is a schematic diagram of a portion of transmit circuitry or receive circuitry of FIG. 2 including a transmit or receive antenna, in accordance with exemplary implementations.

FIG. 4 illustrates a perspective view of an electric vehicle traveling along a roadway in the right lane where the charging base pads are installed in the left lane.

FIG. 5 illustrates an overhead perspective view of the electric vehicle traveling along the roadway of FIG. 4 in the left lane over the charging base pads.

FIG. 6A illustrates a diagram of an exemplary dynamic wireless charging system for charging an electric vehicle depicting a vehicle before it travels above a charging base pad.

FIG. 6B illustrates a diagram of an exemplary dynamic wireless charging system for charging an electric vehicle depicting a vehicle receiving power wirelessly from a charging base pad.

FIG. 7 depicts a functional block diagram of an exemplary dynamic wireless charging system.

FIGS. 8 and 9 depict a flowchart of an exemplary method of charging an electric vehicle according to the dynamic wireless charging system of FIG. 7.

FIG. 10 depicts a graph of the loads of an electric vehicle on two charging base pads.

FIG. 11 represents a flowchart of a method for wirelessly charging an electric vehicle.

FIG. 12 is a functional block diagram of a dynamic wireless charging system that may be employed as depicted in FIG. 1.

### DETAILED DESCRIPTION

The detailed description set forth below in connection with the appended drawings is intended as a description of certain implementations of the invention and is not intended to represent the only implementations in which the invention may be practiced. The term “exemplary” used throughout this description means “serving as an example, instance, or illustration,” and should not necessarily be construed as preferred or advantageous over other exemplary implementations. The detailed description includes specific details for the purpose of providing a thorough understanding of the disclosed implementations. In some instances, some devices are shown in block diagram form.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured by, or coupled by a “receive antenna” to achieve power transfer.

An electric vehicle is used herein to describe a remote system, an example of which is a vehicle that includes, as part of its motion capabilities, electrical power derived from a chargeable energy storage device (e.g., one or more rechargeable electrochemical cells or other type of battery). As non-limiting examples, some electric vehicle may be hybrid electric vehicles that include besides electric motors, a traditional combustion engine for direct locomotion or to charge the vehicle's battery. Other electric vehicles may draw all locomotion ability from electrical power. The electric vehicle is not limited to an automobile and may include motorcycles, carts, scooters, and the like. By way of example and not limitation, a remote system is described herein in the form of the electric vehicle (EV). Furthermore, other remote systems that may be at least partially powered using a chargeable energy storage device are also contemplated (e.g., electronic devices such as personal computing devices and the like).

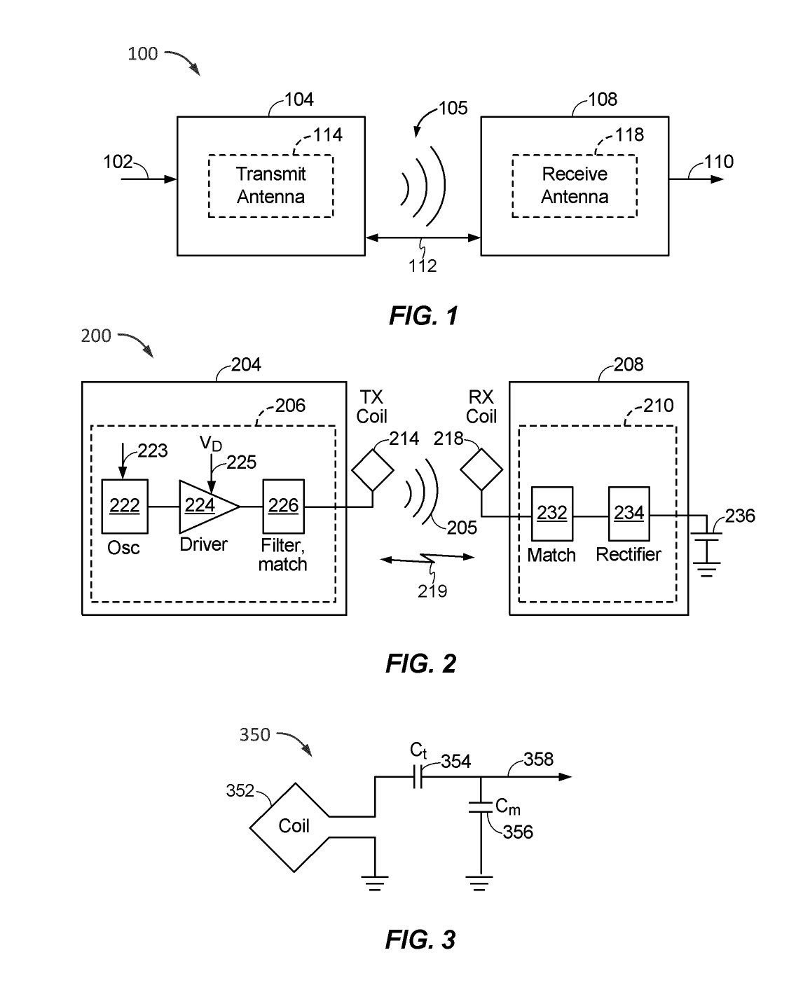

FIG. 1 is a functional block diagram of a wireless power transfer system 100, in accordance with one exemplary implementation. An input power 102 may be provided to a transmitter 104 from a power source (not shown in this figure) to generate a wireless (e.g., magnetic or electromagnetic) field 105 for performing energy transfer. A receiver 108 may couple to the wireless field 105 and generate an output power 110 for storing or consumption by a device (not shown in this figure) coupled to the output power 110. Both the transmitter 104 and the receiver 108 are separated by a distance 112.

In one exemplary implementation, the transmitter 104 and the receiver 108 are configured according to a mutual resonant relationship. When the resonant frequency of the receiver 108 and the resonant frequency of the transmitter 104 are substantially the same or very close, transmission losses between the transmitter 104 and the receiver 108 are minimal. As such, wireless power transfer may be provided over a larger distance in contrast to purely inductive solutions that may require large antenna coils which are very close (e.g., sometimes within millimeters). Resonant inductive coupling techniques may thus allow for improved efficiency and power transfer over various distances and with a variety of inductive coil configurations.

The receiver 108 may receive power when the receiver 108 is located in the wireless field 105 produced by the transmitter 104. The wireless field 105 corresponds to a region where energy output by the transmitter 104 may be captured by the receiver 108. The wireless field 105 may correspond to the “near-field” of the transmitter 104 as will be further described below. The transmitter 104 may include a transmit antenna or coil 114 for transmitting energy to the receiver 108. The receiver 108 may include a receive antenna or coil 118 for receiving or capturing energy transmitted from the transmitter 104. The near-field may correspond to a region in which there are strong reactive fields resulting from the currents and charges in the transmit coil 114 that minimally radiate power away from the transmit coil 114. The near-field may correspond to a region that is within about one wavelength (or a fraction thereof) of the transmit coil 114.

As described above, efficient energy transfer may occur by coupling a large portion of the energy in the wireless field 105 to the receive coil 118 rather than propagating most of the energy in an electromagnetic wave to the far field. When positioned within the wireless field 105, a “coupling mode” may be developed between the transmit coil 114 and the receive coil 118. The area around the transmit antenna 114 and the receive antenna 118 where this coupling may occur is referred to herein as a coupling-mode region.

FIG. 2 is a functional block diagram of a wireless power transfer system 200, in accordance with another exemplary implementation. The system 200 includes a transmitter 204 and a receiver 208. The transmitter 204 may include a transmit circuitry 206 that may include an oscillator 222, a driver circuit 224, and a filter and matching circuit 226. The oscillator 222 may be configured to generate a signal at a desired frequency that may be adjusted in response to a frequency control signal 223. The oscillator 222 may provide the oscillator signal to the driver circuit 224. The driver circuit 224 may be configured to drive the transmit antenna 214 at, for example, a resonant frequency of the transmit antenna 214 based on an input voltage signal (VD) 225. The driver circuit 224 may be a switching amplifier configured to receive a square wave from the oscillator 222 and output a sine wave.

The filter and matching circuit 226 may filter out harmonics or other unwanted frequencies and match the impedance of the transmitter 204 to the transmit antenna 214. As a result of driving the transmit antenna 214, the transmit antenna 214 may generate a wireless field 205 to wirelessly output power at a level sufficient for charging a battery 236 of the electric vehicle 605, for example.

The receiver 208 may include a receive circuitry 210 that may include a matching circuit 232 and a rectifier circuit 234. The matching circuit 232 may match the impedance of the receive circuitry 210 to the receive antenna 218. The rectifier circuit 234 may generate a direct current (DC) power output from an alternate current (AC) power input to charge the battery 236, as shown in FIG. 2. The receiver 208 and the transmitter 204 may additionally communicate on a separate communication channel 219 (e.g., Bluetooth, Zigbee, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236.

FIG. 3 is a schematic diagram of a portion of the transmit circuitry 206 or the receive circuitry 210 of FIG. 2, in accordance with exemplary implementations. As illustrated in FIG. 3, a transmit or receive circuitry 350 may include an antenna 352. The antenna 352 may also be referred to or be configured as a “loop” antenna 352. The antenna 352 may also be referred to herein or be configured as a “magnetic” antenna or an induction coil. The term “antenna” generally refers to a component that may wirelessly output or receive energy for coupling to another “antenna.” The antenna may also be referred to as a coil of a type that is configured to wirelessly output or receive power. As used herein, the antenna 352 is an example of a “power transfer component” of a type that is configured to wirelessly output and/or receive power.

The antenna 352 may include an air core or a physical core such as a ferrite core (not shown in this figure).

As stated, efficient transfer of energy between the transmitter 104 (transmitter 204 as referenced in FIG. 2) and the receiver 108 (receiver 208 as referenced in FIG. 2) may occur during matched or nearly matched resonance between the transmitter 104 and the receiver 108. However, even when resonance between the transmitter 104 and receiver 108 are not matched, energy may be transferred, although the efficiency may be affected. For example, the efficiency may be less when resonance is not matched. Transfer of energy occurs by coupling energy from the wireless field 105 (wireless field 205 as referenced in FIG. 2) of the transmit coil 114 (transmit coil 214 as referenced in FIG. 2) to the receive coil 118 (receive coil 218 as referenced in FIG. 2), residing in the vicinity of the wireless field 105, rather than propagating the energy from the transmit coil 114 into free space.

The resonant frequency of the loop or magnetic antennas is based on the inductance and capacitance. Inductance may be simply the inductance created by the antenna 352, whereas, capacitance may be added to the antenna's inductance to create a resonant structure at a desired resonant frequency. As a non-limiting example, a capacitor 354 and a capacitor 356 may be added to the transmit or receive circuitry 350 to create a resonant circuit that selects a signal 358 at a resonant frequency. Accordingly, for larger diameter antennas, the size of capacitance needed to sustain resonance may decrease as the diameter or inductance of the loop increases.

Furthermore, as the diameter of the antenna increases, the efficient energy transfer area of the near-field may increase. Other resonant circuits formed using other components are also possible. As another non-limiting example, a capacitor may be placed in parallel between the two terminals of the circuitry 350. For transmit antennas, the signal 358, with a frequency that substantially corresponds to the resonant frequency of the antenna 352, may be an input to the antenna 352.

In FIG. 1, the transmitter 104 may output a time varying magnetic (or electromagnetic) field with a frequency corresponding to the resonant frequency of the transmit coil 114. When the receiver 108 is within the wireless field 105, the time varying magnetic (or electromagnetic) field may induce a current in the receive coil 118. As described above, if the receive coil 118 is configured to resonate at the frequency of the transmit coil 114, energy may be efficiently transferred. The AC signal induced in the receive coil 118 may be rectified as described above to produce a DC signal that may be provided to charge or to power a load.

In some wireless vehicle charging systems, the electric vehicle being charged is stationary, i.e., stopped near or above the wireless charging system such that the electric vehicle maintains presence within the wireless field generated by the wireless charging system for transferring charge. Thus, while the electric vehicle is being charged by such a wireless charging system, the electric vehicle may not be used for transportation. Dynamic wireless charging systems that are capable of transferring power while the vehicle is in motion may overcome some of the deficiencies of stationary wireless charging stations.

On a roadway with a dynamic wireless charging system comprising a plurality of the charging circuits placed linearly along a path of travel, the electric vehicle may travel near the plurality of the charging circuits while traveling on the road. A charging circuit may comprise the circuitry and components to effectuate the transfer of wireless power. The charging circuit may comprise one or more of a charging base pad and/or charging coils. The charging pad and/or charging coils may comprise one or more coils capable of generating a wireless field for transferring power wirelessly. In some embodiments, the charging base pad may comprise an apparatus that is configured to generate the wireless field for transferring wireless power; the apparatus may comprise one or more inductive coils or other devices capable of generating the wireless field. Any structure capable of generating the wireless field to transfer power wirelessly may function as the charging base pad in the system described herein. Should the electric vehicle desire to charge its batteries or source energy to power the electric vehicle while traveling, in order to extend its range or reduce the need to charge later, the electric vehicle may request the dynamic wireless charging system activate the charging base pads along the electric vehicle's path of travel. Such dynamic charging may also serve to reduce or eliminate the need for auxiliary or supplemental motor systems in addition to the electric locomotion system of the electric vehicle 605 (e.g., a secondary gasoline engine of the a hybrid/electric vehicle 605). As such, dynamic wireless charging systems and methods that efficiently and effectively activate the charging base pads along a path of travel of the electric vehicle are needed.

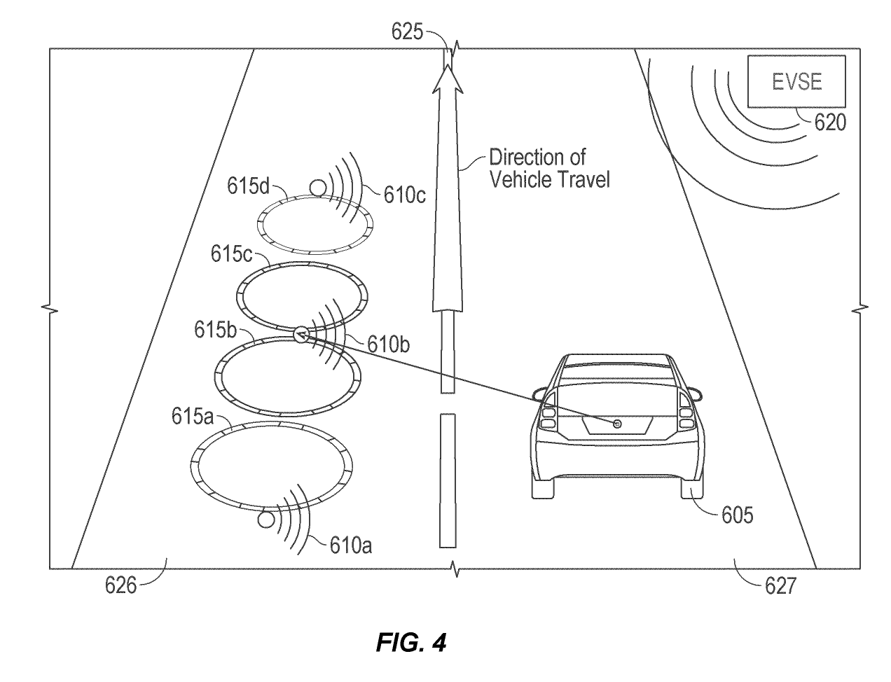

FIG. 4 illustrates a perspective view of the electric vehicle 605 traveling along a roadway 625 in the right lane where the charging base pads of the dynamic wireless charging system generally referred to as 600, are installed in the left lane. As depicted, the electric vehicle 605 is traveling along the roadway 625. The direction of travel along the roadway 625 in the drawing is from the bottom of the page to the top of the page. FIG. 4 depicts two lanes of travel for the roadway 625, a left lane 626 and a right lane 627. The electric vehicle 605 is traveling in the right lane 627 and is beside the charging base pad 615a that in the left lane 626. The Electric Vehicle Support Equipment (the EVSE) 620 is shown off the roadway 625 broadcasting a signal to or receiving a signal from passing electric vehicles 605. The left lane 626 includes a plurality of charging base pads 615a-615d positioned linearly end to end along the center of the roadway 625, with the charging base pad 615a being the first to be passed by a vehicle traveling along the roadway 625 and base pad 615d being the last to be passed. The left lane 626 also contains one or more proximity devices 610a-610c located among the charging base pads 615a-615d.

The EVSE 620 may receive charging requests from the passing electric vehicle 605 on the roadway 625 or broadcast the services of the dynamic wireless charging system 600 to a passing electric vehicle 605 along the roadway 625 regardless of what lane, left lane 626 or right lane 627, the electric vehicle 605 is in. The EVSE 620 may check to determine whether the electric vehicle 605 is allowed to receive a charge from the charging base pads 615a-615d (i.e., the electric vehicle 605 charging circuitry is compatible with the charging circuitry of the dynamic wireless charging system 600, or the electric vehicle 605 has an approved account that will be debited for any charging services provided by the dynamic wireless charging system 600). This determination may involve validation of various elements, including account information, vehicle type, charger type, charging requirements, current charging system operation, vehicle speed and alignment to charging system, etc. These communications may be performed via charging communication or via other communication protocols and methods. In some embodiments, an authentication process with the EVSE 620 may be extended to personal devices (e.g., a cell phone) of the driver of the electric vehicle 605. Any negotiations or handshaking required between the dynamic wireless charging system 600 and the electric vehicle 605 before the electric vehicle 605 is allowed to receive a charge may take place via these communications. Further, the electric vehicle 605 may communicate its GPS position, direction vector, and speed to the EVSE 620. The EVSE 620 may communicate with the electric vehicle 605 via Bluetooth, LTE, Wi-Fi, DSRC, or any similar manner of communication.

If the electric vehicle 605 is determined to be allowed to receive a charge, the EVSE 620 may provide additional communications or visual indicators (not shown in this figure) regarding the alignment of the electric vehicle 605 along the width of the roadway 625 to the electric vehicle 605 or to the operator therein. Additionally, the EVSE 620 may provide indicators of the locations of the charging base pads 615a-615d. The additional communications or visual indicators may instruct the electric vehicle 605 or its operator to how and where to move the electric vehicle 605 to the left lane 626 where the charging base pads 615a-615d are installed.

Additionally, the EVSE 620 may activate a charging base pad controller 630 (not shown in this figure) and the proximity devices 610a-610c. Activating the charging base pad controller 630 comprises providing the charging base pad controller 630 the power needed to function. In another embodiment, activating the charging base pad controller 630 may comprise providing a signal enabling the charging base pad controller 630 to control the charging base pads 615a-615d. The charging base pad controller 630 may be deactivated prior to the EVSE 620 determining the electric vehicle 605 is allowed to charge in order to save energy and ensure the charging base pads 615a-615d do not generate a wireless field 635 improperly.

Activating the proximity devices 610a-610c may include providing the proximity devices 610a-610c the power needed to function as provide a detection signal. The proximity device 610a-610c may be deactivated prior to the EVSE 620 determining the electric vehicle 605 is allowed to charge in order to save energy. In an embodiment, the charging base pad controller 630 may be incorporated into the EVSE 620. In another embodiment, the charging base pad controller 630 may be a separate equipment. In some other embodiment, the proximity devices 610a-610c may be activated by the charging base pad controller 630. Additionally, an embodiment may use the communicated information to determine if the electric vehicle 605 is leaving the lane in which the charging base pads 615a-615d are installed.

The proximity devices 610a-610c may provide a signal when they detect the presence of the electric vehicle 605. The proximity devices 610a-610c may be placed along the path of the roadway 625 such that the electric vehicles 605 traveling along the roadway 625 are detected by one of the proximity devices 610a-610c before the electric vehicle 605 passes above the charging base pads 615a-615d without requiring any communication with the electric vehicle 605. When the proximity device 610 detects the electric vehicle 605, it may generate an output signal to another device. In an embodiment, the other device may be the EVSE 620. In an alternative embodiment, the proximity receiver antenna of a proximity system may be mounted on the electric vehicle 605, with the transmitter installed within or alongside the roadway 625. In such an embodiment, the electric vehicle 605 may communicate receipt of the signal to the EVSE 620 when the electric vehicle 605 enters the range of the proximity transmitter, giving a location estimate to activate the next set of charging base pads 615. For example, if the proximity transmitter is generating a magnetic beacon before the charging base pads 615, when the electric vehicle 605 enters the range of the magnetic beacon, the proximity receiver antenna may detect the magnetic beacon and estimate the distance from the proximity transmitter based on the power level of the magnetic beacon. The electric vehicle 605 may communicate its estimated location in order to activate the charging base pads 615, or the electric vehicle 605 may generate the communication to the EVSE when the magnetic beacon changes angle by 180 degrees, indicating the electric vehicle 605 passed the proximity transmitter. In another embodiment, the other device may be the charging base pad controller 630. In an embodiment, the proximity devices 610a-610d may be inductive sensors, wherein an inductive load indicates the presence of the electric vehicle 605 which is communicated to the other device (i.e., the EVSE). In another embodiment, the proximity device 610 may be a proximity transmitter (not shown) mounted along the roadway with a proximity receiver mounted (not shown) on the electric vehicle 605. As the electric vehicle 605 approaches the charging pads 615, the proximity receiver may generate a signal once in proximity to the proximity transmitter. The generated signal may then be communicated to the EVSE to give a rough location estimate of the electric vehicle 605 to be used to activate the subsequent charging pads. In another embodiment, the proximity device 610 may be charging base pad 615 that is not delivering wireless power. The proximity device 610a may be positioned before the charging base pad 615a. Additionally, proximity device 610b may be located between the charging base pads 615b and 615c. In an embodiment, the proximity device 610b may provide detection of any electric vehicle 605 that enters the left lane 626 after passing the proximity device 610a. The proximity device 610c may be located after the charging base pad 615d. The proximity device 610c may indicate when the electric vehicle 605 passes the charging base pad 615c. In an embodiment, additional proximity devices 610 (not shown in this figure) may be installed between each charging base pad 615a-615d. More proximity devices 610 may provide more opportunities to detect the electric vehicle 605 that enters the left lane 626 after passing the first the proximity device 610 and the first charging base pad 615a.

The proximity signal from the proximity devices 610a-610c may be used to track the electric vehicle 605 duration within the wireless fields 635a-635d of the charging base pads 615a-615d or to verify position calculations as determined by the charging base pad controller 630 load profile analysis. The load profile analysis as described herein may refer to the detection of changes in an electrical characteristic (e.g., current flow) in the charging base pad 615 caused by the electric vehicle 605 as the electric vehicle 605 is moving and use of those detected changes to determine a location of the electric vehicle 605. In other embodiments, other methods of determining a location of the electric vehicle 605 by detecting changes in other electrical characteristics of a charging base pad caused by the electric vehicle 605 may be performed. Other electrical characteristics may comprise a voltage, a resistance, an impedance, a capacitance, etc.

In another embodiment, the proximity device 610 may generate a signal communicated to the electric vehicle 605 to inform the electric vehicle 605 that it is entering an area serviced by the dynamic wireless charging system 600. The signal may be communicated to the electric vehicle 605 via the EVSE 620, the charging base pad controller 630, directly from the proximity device 610, or via roadside signs and/or indicators. The signal may be communicated via any communication means (e.g., magnetic beaconing, cellular communications, Wi-Fi, RFID, etc.). The electric vehicle 605 may use this proximity signal communicated for any number of purposes, e.g., to activate the electric vehicle 605 wireless charging circuit and the power receiving pad 606, to provide an alert or message to the operator indicating that the electric vehicle 605 is nearing or above one of the charging base pads 615a-615d, to activate alignment and charging position detection, etc.

The charging base pad controller 630 may control the activation of one or more of the charging base pads 615a-615d. The charging base pad controller 630 may not activate the charging base pads 615a-615d until one of the proximity devices 610a-610c detects the electric vehicle 605 in the left lane 626 and sends a signal indicating such detection to the charging base pad controller 630. This ensures that the charging base pads 615a-615d are not improperly activated, i.e., activated when there is not an electric vehicle 605 being allowed to receive a charge from the charging base pads 615a-615d above the charging base pads 615a-615d.

The charging base pads 615a-615d may provide the transfer of power to the electric vehicle 605. The charging base pads 615a-615d may receive an input signal provided by the charging base pad controller 630 or of input power and generate a wireless field 635a-635d through which power may wirelessly be transferred to a device entering into the wireless field 635a-635d, e.g., the electric car 605. The charging base pads 615 may comprise a loop antenna as described with reference to FIG. 3 above.

The charging base pads 615a-615d may be embedded in the roadway 625 such that the electric vehicle 605 traveling along the roadway 625 pass above the charging base pads 615a-615d. In such an instance, the electric vehicle 605 may comprise a battery (not shown in this figure), a charging circuit (not shown in this figure), and a power receiving pad 606 (not shown in this figure) located on the bottom of the electric vehicle 605 such that there is minimal interference and distance between the power receiving pad 606 and the charging base pads 615a-615d in the roadway 625. In another embodiment, the charging base pads 615a-615d may be mounted along the side of the roadway 625 or above the roadway 625. In other embodiments, the electric vehicle 605, comprising the battery and charging circuit, may have the power receiving pad 606 located such that it is capable of receiving wireless power from the charging base pads 615a-615d. In even other embodiments, the electric vehicle 605 may not comprise a battery, but instead use energy received from the charging base pads 615a-615d to generate locomotive force to propel the electric vehicle 605 or power vehicle devices. The charging base pads 615a-615d may be designed such that they maximize efficient transfer of wireless power to the power receiving pad 606.

In an embodiment, the size of the charging base pads 615a-615d may of a diameter of half a meter (0.5 m). In some other embodiment, the charging base pads 615a-615d may be of a diameter of more than half a meter. In some other embodiment, the charging base pads 615a-615d may be of a diameter less than half a meter. In another embodiment, the charging base pads 615a-615d may be of a non-circular shape, for example, but not limited to, rectangular, octagonal, elliptical, etc. A person of ordinary skill may know the size of the charging base pads 615 may vary with the power transfer requirements. The size of the charging base pads 615a-615d may be established by a calculation of what size provides the most efficient power transfer for the greatest amount of power transmission within a distance.

Additionally, the charging base pads 615a-615d may be spaced along the roadway 625 with a distance between each pad 615a-615d such that the power receiving pad 606 on the electric vehicle 605 may continuously receive wireless power from at least one the charging base pad 615 while traveling along the roadway 625. In an embodiment, the charging base pads 615a-615d may be installed in the roadway 625 end to end such that there is no space between the charging base pads 615a-615d and thus no location where the electric car 605 may not receive wireless power. In another embodiment, the charging base pads 615a-615d may be installed with a distance of half a meter (0.5 m) between each of the charging base pads 615a-615d. In another embodiment, the charging base pads 615 may be spaced such that no two wireless fields 635 overlap. In some embodiments, the charging base pads 615a-615d may overlap with each other. In another embodiment, the charging base pads 615 may be spaced such that the most efficient transfer permitted by ensuring now two wireless fields 635 overlap.

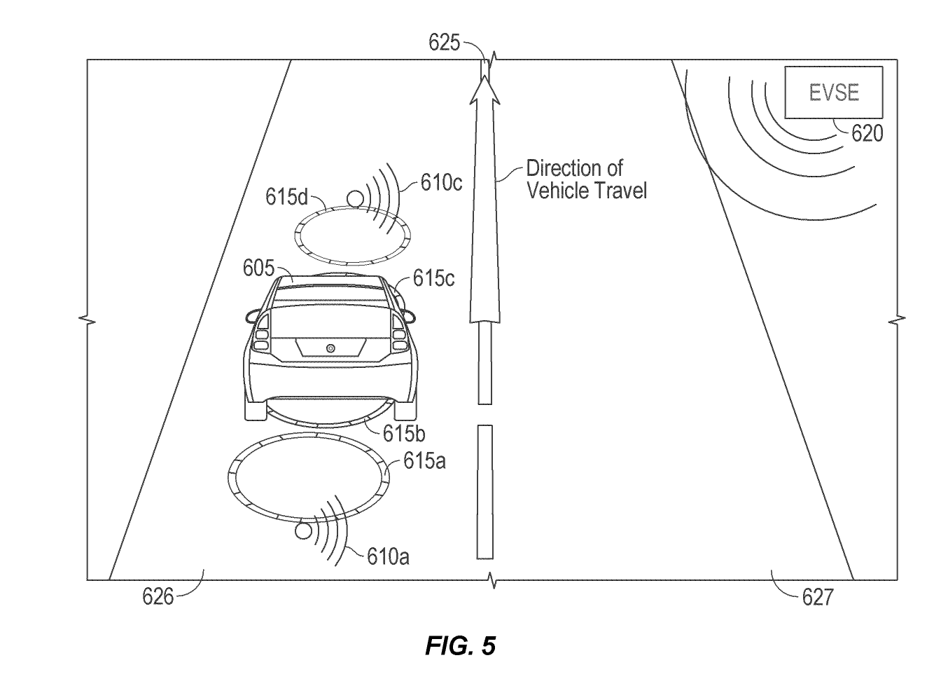

FIG. 5 illustrates an overhead perspective view of the electric vehicle 605 traveling along the roadway 625 of FIG. 4 in the left lane 626 over the charging base pad 615b. FIG. 5 depicts the same elements as FIG. 4, and the direction of travel is from the bottom of the page to the top of the page. FIG. 5 depicts the electric vehicle 605 traveling in the left lane 626 above the charging base pad 615b after moving from the right lane 627 as depicted in FIG. 4.

If the EVSE 620 determined the electric vehicle 605 is allowed to receive a charge, the EVSE 620 may activate the charging base pad controller 630 (not shown in this figure) as mentioned above. The charging base pad controller 630 or the EVSE 620 may then activate one or more of the proximity devices 610a-610c to determine when to activate the individual the charging base pads 615b-615d. Since the electric vehicle 605 moved to the left lane 626 from the right lane 627 after passing the proximity device 610a, the charging base pad controller 630 did not activate any of the charging base pads 615a-615 because proximity device 610a did not detect the electric vehicle 605. Therefore, the electric vehicle 605 is not receiving a charge and the charging base pad controller 630 is unable to estimate the position of the vehicle from the charging base pads 615a-615d.

Once the proximity devices 610a-610c have been activated, the proximity device 610b (not shown in this figure) may detect the electric vehicle 605 as the electric vehicle 605 travels from the charging base pad 615b to the charging base pad 615c. When the proximity device 610b detects the electric vehicle 605, it may send a signal to the charging base pad controller 630 indicating the detection of the electric vehicle 605. The charging base pad controller 630 may receive that signal and activate the first charging base pad 615 in the path of the vehicle in anticipation of the electric vehicle 605 traveling over it, here charging base pad 615c. The charging base pad controller 630 may determine the time at which to activate the charging base pad 615c based upon the vehicle speed, direction vector, and position communicated to the EVSE 620 from the electric vehicle 605 and/or determined from the proximity signals from the proximity devices 610a-610c.

Once the electric vehicle 605 passes above the activated charging base pad 615c, the charging base pad controller 630 may use load profile analysis or similar methods to determine when the electric vehicle 605 is transitioning between the charging base pads 615b and 615c and further transitioning between the charging base pads 615c and 615d. The load profile analysis, as will be described in detail below, may allow the charging base pad controller 630 to activate the subsequent charging base pad 615d and deactivate the prior charging base pad 615c in an efficient manner.

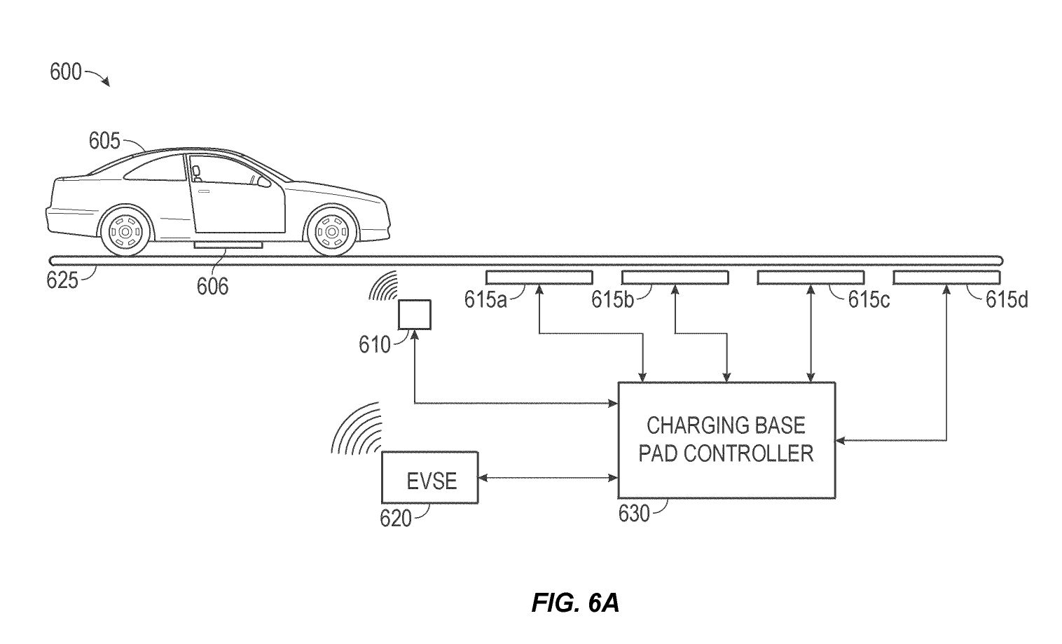

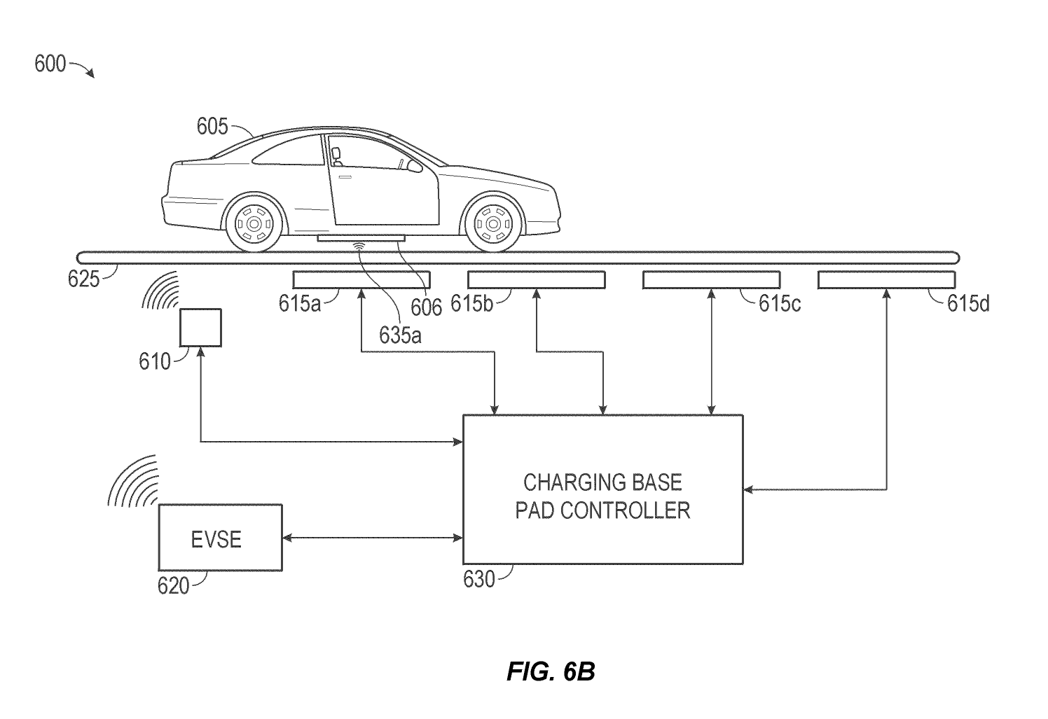

FIG. 6A illustrates a diagram of an exemplary dynamic wireless charging system 600 for charging the electric vehicle 605, in accordance with one exemplary implementation. FIG. 6A depicts a side view of the electric vehicle 605 traveling along the roadway 625. The direction of travel along the roadway 625 is from the left to the right of the page. The dynamic wireless charging system 600 may be installed along the roadway 625 such that one or more the electric vehicles 605 traveling on the roadway 625 may obtain power from the charging base pads 615a-615d while the electric vehicle 605. The dynamic wireless charging system 600 may comprise the EVSE 620 connected to a charging base pad controller 630. The charging base pad controller 630 may be connected to one or more charging base pads 615a-615d, each of which are deactivated so as to not improperly generate a wireless field 635. Additionally, one or more proximity devices 610a-610c may be connected to either the EVSE 620 or the charging base pad controller 630. Additionally, the dynamic wireless charging system 600 may utilize at least one roadway 625 along which the dynamic wireless charging system 600 may be installed and at least one electric vehicle 605 with at least one power receiving pad 606, which may wirelessly obtain electric power from one or more of the charging base pads 615a-615d via the power receiving pad 606. In another embodiment, the EVSE 620 and the charging base pad controller 630 may be combined into a single unit.

The dynamic wireless charging system 600 functions to transfer wireless power to an object in motion, e.g., the electric vehicle 605. In one embodiment, the dynamic wireless charging system 600 may enable the wireless charging of a battery (not shown in this figure) of the electric vehicle 605 traveling along the roadway 625 above the charging base pads 615a-615d. As discussed above, the EVSE 620 may perform the initial communications between the dynamic wireless charging system 600 and the electric vehicle 605. Once all permissions have been granted and the electric vehicle 605 is determined to be allowed to charge from the charging base pads 615a-615d, the EVSE 620 may activate the proximity devices 610 and the charging base pad controller 630. The charging base pad controller 630 may control the activation and deactivation of the charging base pads 615a-615d connected to the charging base pad controller 630 and may perform the load profile analysis of the connected the charging base pads 615a-615d to estimate the position of the electric vehicle 605 receiving wireless power from the charging base pads 615a-615d while the electric vehicle 605 is in motion. Details of the load profile analysis process will be discussed below.

The proximity device 610 may function to detect when the electric vehicle 605 or other electric device capable of wireless power transfer enters the vicinity of the charging base pads 615a-615d. The charging base pads 615a-615d may provide the wireless power to the electric vehicle 605 or other electric device capable of wireless charging via at least one wireless field 635a-635d. The roadway 625 may serve as the point of installation for the dynamic wireless charging system 600. The electric vehicle 605 may function to transport people or objects between locations using electric force. Continued driving may drain the charge contained within the battery. The power receiving pad 606 of the electric vehicle 605 may be used to receive power transmitted wirelessly by the charging base pads 615a-615d. The power receiving pad 606 may be connected to the battery to charge it via a charging circuit (not shown in this figure) or to the electric motor providing motion to the electric vehicle 605.

The charging base pad controller 630 may control the charging base pads 615a-615d such that they are activated and deactivated as desired in relation to the electric vehicle 605. The dynamic wireless charging system 600 may comprise at least one the charging base pad controller 630, which may provide activation and deactivation control to at least one charging base pad 615. The charging base pad controller 630 may be connected to each of the charging base pads 615a-615d that the charging base pad controller 630 controls. In an alternate embodiment, the charging base pad controller 630 may be integrated into the EVSE 620, such that the EVSE 620 controller serves to control the charging base pads 615a-615d and each the charging base pads 615a-615d may be connected directly to the EVSE 620.

Additionally, the charging base pad controller 630 may perform the calculations for the load profile analysis discussed herein. The said load profile analysis may allow the charging base pad controller 630 to estimate the position of the electric vehicle 605 while the electric vehicle 605 is moving along the roadway 625 above the charging base pads 615a-615d and receiving wireless power from the charging base pads 615a-615d via wireless field 635a-635d. The charging base pad controller 630 may determine the position of the electric vehicle 605 using the analysis of the load profile of the electric vehicle 605. Using load profile analysis to determine the position of the electric vehicle 605 above the charging base pad 615 may provide greater resolution, accuracy, robustness of the system, and real time capability of the position estimation of the dynamic wireless charging system 600.

In an embodiment, the receiver used by the electric vehicle 605 may be a coil antenna and the charging base pad 615a-615d may comprise a coil antenna. In an alternate embodiment, either or both of the power receiving pad 606 and the charging base pad 615 may be a loop antenna as described above in reference to FIG. 3.

FIG. 6B illustrates a diagram of an exemplary dynamic wireless charging system 600 for charging the electric vehicle 605, depicting the electric vehicle 605 receiving power wirelessly from the charging base pad 615a. FIG. 6B depicts virtually all of the same elements and functions as FIG. 6A.

FIG. 6B also includes wireless fields 635a-635b which are generated by the activated charging base pads 615a and 615b. As depicted, only the charging base pad 615a and 615b are currently activated and generating wireless fields 635a and 635b. In an alternate embodiment, only the wireless field 635a generated by the charging base pad 615a may be depicted while the electric vehicle 604 is above only the charging base pad 615a. The wireless field 635a-635d is generated in the area immediately above the charging base pads 615a-615d. FIG. 6B shows the electric vehicle 605 with the power receiving pad 606 driving over the charging base pad 615a. As shown, the power receiving pad 606 is within the wireless field 635a and receiving power wirelessly from the charging base pad 615a of the dynamic wireless charging system 600. The power receiving pad 606 then directs that received power to charge the battery (not shown in this figure) of the electric vehicle 605 or provide power to the motor of the electric vehicle 605. The operator of the electric vehicle 605, the electric vehicle 605, or the dynamic wireless charging system 600 may select whether to charge the battery of the electric vehicle 605 or use the wireless power to provide power directly to the motor of the electric vehicle 605.

The intensity of the wireless field 635 may vary with respect to the location in the wireless field 635. The portion of the wireless field 635 above the center of the charging base pad 615 (center of wireless field 635) may be of greater intensity than the intensity of the wireless field 635 above the edge of the charging base pad 615 (edge of the wireless field 635). In an embodiment, the wireless fields 635a-635d generated by each of the charging base pads 615a-615d may extend outside the area immediately above the charging base pads 615a-615d.

Existing position detection systems may utilize Global Navigation Satellite Systems (GNSS), or GPS to determine the position or location of the electric vehicle 605 for use in a dynamic wireless charging system 600, but may only be accurate to a resolution of 2 meters. Further, the communication time period for the electric vehicle 605 traveling at a velocity of 30-75 mph to receive its GNSS or GPS position and communicate it to the EVSE 620 may require 10 ms (microseconds) (more likely 50 ms) and may have a considerable amount of random jitter added to it, further distorting the resolution. The electric vehicle 605 traveling at 30-75 mph may travel between 13 cm and 33 cm in that 10 ms period of communication. Thus, the resolution of the existing GNSS and GPS position detection systems may not be any better than 13 cm, compounded by the potential error rate of the GNSS/GPS resolution (comprising a total range of up to 2.33 meters or 466% of the length of the charging base pad 615). With the charging base pads 615 having a diameter of 0.5 m, this resolution may place the electric vehicle 605 in the vicinity the length of up to 5 the charging base pads 615, thus requiring the dynamic wireless charging system 600 to activate more the charging base pads 615 than necessary and making the dynamic wireless charging system 600 less efficient or harmful to other traffic. The electric vehicle 605 maintains the equipment to determine its GNSS/GPS position and communicates said position to the dynamic wireless charging system 600 via communications methods discussed above.

Alternate embodiments of existing position detection systems of roadside charging systems may utilize the proximity devices embedded into the road (e.g., RF devices, Bluetooth LE devices, MAD sensors, magnetic beacon sensor systems) that may provide position resolution at about 50 cm (100% of the length of the charging base pad 615), which may require the dynamic wireless charging system 600 to activate up to 2 the charging base pads 615 to ensure the electric vehicle 605 is capable of receiving wireless power. While position detection systems utilizing these devices may be more accurate than the GNSS/GPS based position detection systems, such systems may require the dynamic wireless charging system 600 to incorporate special hardware to support the position detection equipment to determine the position of the electric vehicle 605 above the charging base pads 615a-615d. Additionally, some of these methods may require additional equipment to be installed on the electric vehicle 605, adding cost to both the charging system 600 and the electric vehicle 605.

In some embodiments, load profile analysis as described herein may be used to beneficially determine a position, a speed and/or a vector of an electric vehicle. The position, speed and/or vector determinations may be used to schedule the activation of subsequent charging base pads a distance down the roadway 625. In some embodiments, additional charging base pads may be used to verify the scheduling of the subsequent base pads to ensure the scheduling is accurate and updating the scheduling as desired. In an alternate embodiment, the load profile analysis may be used to activate adjacent charging base pads 615 immediately as opposed to scheduling activations.

Load profile analysis may comprise the measuring of the load of the electric vehicle 605 on the charging base pad 615. This may be performed by measuring the electric current draw on the charging base pad 615. As the electric vehicle 605 travels above the charging base pad 615, the amount of current draw on the charging base pad 615 may fluctuate according to the position of the electric vehicle 605 above the charging base pad 615. For example, when the electric vehicle 605 is above the roadway 625 immediately before the charging base pad 615, the current draw on the charging base pad 615 may be slight, and based on the amount of current draw, the dynamic wireless charging system may determine that the electric vehicle 605 is approaching the charging base pad 615 and located immediately before the charging base pad 615. Alternatively, when the electric vehicle 605 is above the center of the charging base pad 615, the current draw on the charging base pad 615 may be of such a value that the dynamic wireless charging system 600 may determine that the electric vehicle 605 is above the center of the charging base pad 615. Accordingly, each position of the charging base pad 615 may correspond to a distinct load measurement based on the current measurement that may allow the dynamic wireless charging system 600 (via at least one of the EVSE 620, the position circuit 730, the load circuit 728, the controller 724, or the charging base pad driver 726) to determine a specific location of the electric vehicle 605 above the charging base pad 615.

In an exemplary embodiment of the present invention, the charging base pad controller 630 may utilize load profile analysis to determine the position of the electric vehicle 605 above the charging base pads 615a-615d. As the charging base pad 615 of the charging system 600 is fixed in position along the roadway 625 and the electric vehicle 605 with the power receiving pad 606 is moving, the load profile of the electric vehicle 605 with the power receiving pad 606 on the active the charging base pad 615 will change as it moves through the wireless fields 635a-635d generated by the charging base pads 615a-615d. The resulting load profile correlates the position of the electric vehicle 605 and the power receiving pad 606 in relation to a current draw on the charging base pad 615 and can provide a very accurate position, potentially better than 1 cm. The charging base pad 615 may provide wireless power at a frequency of 40 kHz resulting in a load determination duration of 25 us (microseconds). In other embodiments, faster charging frequencies may provide for shorter durations, thus making the resulting position detection more precise. However, assuming a filtered current read-out cycle of 100 us (microseconds), the resolution of the position estimation of the electric vehicle 605 traveling over the charging base pad 615 at 75 mph may be as small as 0.33 cm, or 0.6% of the charging base pad 615 length. Thus, only one the charging base pad 615 may need to be activated to ensure the electric vehicle 605 and the power receiving pad 606 are within a wireless field 635 generated by the charging base pad 615 to receive wireless power.

As the electric vehicle 605 with the power receiving pad 606 passes above the charging base pad 615a, the load on the charging base pad 615 will fluctuate based on the location of the power receiving pad 606 within the wireless field 635 of the charging base pad 615. The charging base pad controller 630 may use indications of changes in this load to perform an analysis on the electric vehicle 605 location. The load may represent the strength of the wireless power transfer taking place. When the electric vehicle 605 and its power receiving pad 606 first enter the wireless field 635 generated above an active the charging base pad 615, the load on the charging base pad 615 may be low where the intensity of the wireless field 635 is low at the edge of the charging base pad 615. As the power receiving pad 606 continues to pass through the wireless field 635, the wireless field 635 intensity and/or the coupling between the charging base pad 615 and the power receiving pad 606 rises and thus the load of the power receiving pad 606 of the electric vehicle 605 rises as the power transfer increases. The load presented to the charging base pad 615 by the electric vehicle 605 may be at its greatest when the power receiving pad 606 of the electric vehicle 605 is centered above the charging base pad 615a such that the maximum wireless energy transfer is being performed. As the electric vehicle 605 and the power receiving pad 606 continue to travel through the wireless field 635 generated by the charging base pad 615, away from the center of the wireless field 635 and toward its edge, the load on the charging base pad 615 begins to drop. The charging base pad controller 630 may monitor the load on the charging base pad 615 to determine when to activate the second charging base bad 615 and when to deactivate the first charging base pad 615. In some embodiments, a smoother power transfer may be accomplished by maintaining at least two charging base pads 615 active at all times. For example, as the electric vehicle 605 travels over the charging base pads 615a-615d, as the electric vehicle 605 begins to leave active charging base pad 615a, and active base pad 615a lowers its current, charging base pad 615b may be active at full power as charging base pad 615c activates and starts to raise its power. Thus, as the electric vehicle 605 passes a charging base pad 615, the next two successive charging base pads 615 may already be activated. In another embodiment, the charging base pad controller 630 may monitor the loads on the charging base pads 615 and activate as many charging base pads 615 as necessary to provide smooth and efficient power transfer. In an embodiment, charging base pad controller 630 may activate more than two charging base pads 615 at a time, for example, when the first charging base pad 615a remains activated as the second charging base pad 615b begins charging the electric vehicle 605 and the third charging base pad 615c activates to prepare to charge the electric vehicle 605.

The charging base pad controller 630 may determine that a first threshold level of the load of the first charging base pad 615 corresponds to the electric vehicle 605 with the power receiving pad 606 beginning to exit the wireless field 635 of the first the charging base pad 615. The charging base pad controller 630 may further determine that a second threshold level of the load on the first the charging base pad 615 corresponds to the electric vehicle 605 with the power receiving pad 606 having entirely exited the wireless field 635 of the first the charging base pad 615. In an embodiment, when the load of the electric vehicle 605 on the first charging base pad 615 drops below the first threshold level, the charging base pad controller 630 may activate the second charging base pad 615 such that the electric vehicle 605 is continuously receiving wireless power while traveling above or between the charging base pads 615a-615d. Further, as the load of the first charging base pad 615 from the electric vehicle 605 with the power receiving pad 606 continues to drop below the second threshold level, the charging base pad controller 630 may deactivate the first charging base pad 615. In an embodiment, the first and second threshold levels may be established and stored within the dynamic wireless charging system 600 memory (of the EVSE or charging base pad controller 630) by the manufacturer. In another embodiment, the threshold levels may be communicated to the charging base pad controller 630 from the EVSE 620, the EVSE 620 having the threshold levels established and saved in memory. In some other embodiment, the threshold levels may be communicated to the charging base pad controller 630 from the electric vehicle 605 being charged such that each the electric vehicle 605 provides a dynamic wireless charging system 600 with associated parameters for proper operation. In another embodiment, the first and second thresholds may be combined into a single threshold representing when the charging base pad controller 630 is to deactivate the first the charging base pad 615 and activate the second the charging base pad 615 concurrently.

The charging base pad controller 630 may monitor the load of the electric vehicle 605 and the power receiving pad 606 from the first the charging base pad 615 to determine when to activate the second the charging base pad 615. As discussed above, load profile analysis may be used to determine the position of the electric vehicle 605 within a centimeter. Such precise control of the activation and deactivation of the charging base pads 615 may ensure that the charging base pads 615 will not be activated when a person or non- the electric vehicle 605 is positioned in the wireless field and that the charging base pads 615 will be deactivated as soon as they are not providing for power transfer to the electric vehicle 605.

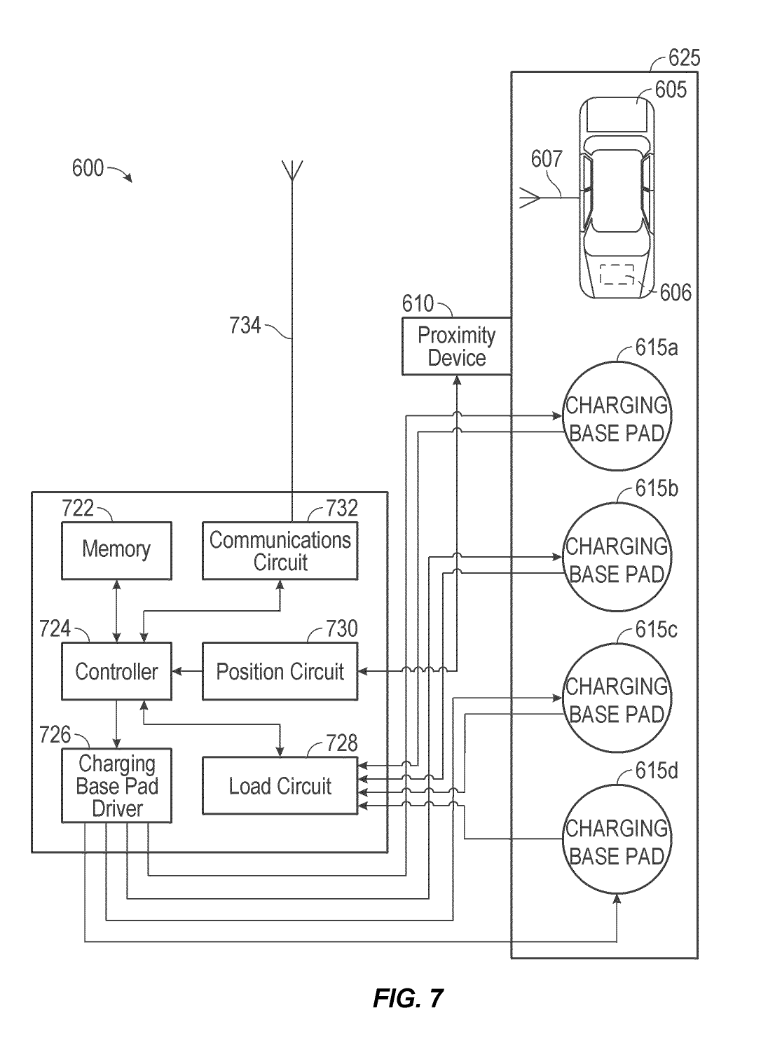

FIG. 7 depicts a functional block diagram of an exemplary dynamic wireless charging system 600. The electric vehicle 605 is depicted driving along the roadway 625. The electric vehicle 605 is traveling across the page from top to bottom. The electric vehicle 605 may be communicating with the communication circuit 732 of the dynamic wireless charging system 600. The communication circuit 732 may be connected to the controller circuit 724. The controller circuit 724 may be connected to each circuit in the dynamic wireless system 600. The controller circuit 724 may be connected to the memory circuit 722. Additionally, the controller circuit 724 may be connected to the proximity circuit 730. The controller circuit 724 is also connected to the load circuit 728 and the charging base pad driver circuit 726. Both the load circuit 728 and the charging base pad driver circuit driver circuit 726 are connected to the charging base pads 615a-615d. The charging base pads 615a-615d are along the path of the electric vehicle 605 on the roadway 625.

The communication circuit 732 may perform the communications between the dynamic wireless charging system 600 and the electric vehicle 605 and between the dynamic wireless charging system 600 and any other external systems or devices. The communications performed may be via Bluetooth, LTE, Wi-Fi, or any manner of bi-directional communication. The communication circuit 732 may broadcast to passing electric vehicles 605 or may receive charge requests from the electric vehicles 605. The communication circuit 732 may detect electric vehicles 605. The communication circuit 732 may receive the speed, location, and vector information from the electric vehicle 605. Additionally, the communication circuit 732 communicates with the electric vehicle 605 to receive information to determine if the electric vehicle 605 is allowed to receive a charge from the dynamic wireless charging system 600 (i.e., information regarding the electric vehicle 605 charging system, power requirements, etc.). Additionally, the communication circuit 732 may activate visual indicators or provide communications to the electric vehicle 605 for alignment purposes. The communication circuit 732 may correspond to the EVSE 620, the proximity device 610, or the charging base pad controller 630 of the dynamic wireless charging system 600.

The memory circuit 722 may perform the storage of thresholds from the load profile analysis and may save information from the electric vehicles 605 that are allowed to use the dynamic wireless charging system 600 and do receive a charge from the charging base pads 615a-615d. This may include billing information, time information, and electric vehicle 605 identification information. The memory circuit 722 may correspond to the EVSE 620 or the charging base pad controller 630 of the dynamic wireless charging system 600.

The proximity circuit 730 may perform the determination of the presence of the electric vehicle 605. The proximity circuit 730 may generate and/or provide a signal of the detection of the electric vehicle 605 to the controller 724 or the charging base pad driver 726. The proximity circuit 730 may detect the electric vehicle 605 by monitoring the current flow at the charging base pads 615 as affected by the electric vehicle 605. The current flow (i.e., load of the electric vehicle 605) may fluctuate in relation to the electric vehicle 605 position above the charging base pad 615 as the electric vehicle 605 travels above the charging base pads 615. This proximity circuit 730 may be one embodiment of detecting changes in current flow in the charging base pad 615 caused by the electric vehicle 605 in order to determine a location of the electric vehicle 605. The proximity circuit 730 may track the travel of electric vehicle 605 across multiple proximity devices 610 or in some embodiments, the charging base pads 615a-615d. In another embodiment, the proximity circuit 730 may confirm the speed, vector, and position information communicated to the EVSE 620 from the electric vehicle 605. The proximity circuit 730 may correspond to the EVSE 620, the charging base pad controller 630, or the proximity device 610.

The charging base pad driver circuit 726 may perform the activation and deactivation of the charging base pads 615a-615d. The charging base pad driver circuit 726 may receive a signal from the controller circuit 724 based upon the determination of when an electric vehicle 605 may above the charging base pad 615. In another embodiment, the charging base pad driver circuit 726 may receive the electric vehicle 605 detection signal directly from the proximity circuit 730. In response to these signals, the charging base pad circuit 715 may activated or deactivate the charging base pads 615a-615d. The charging base pad driver circuit 726 may correspond to the EVSE 620 or the charging base pad controller 630. While one proximity device 610 is show in FIG. 7, multiple proximity devices (not shown) may be used in FIG. 7 at different positions along the road 625.

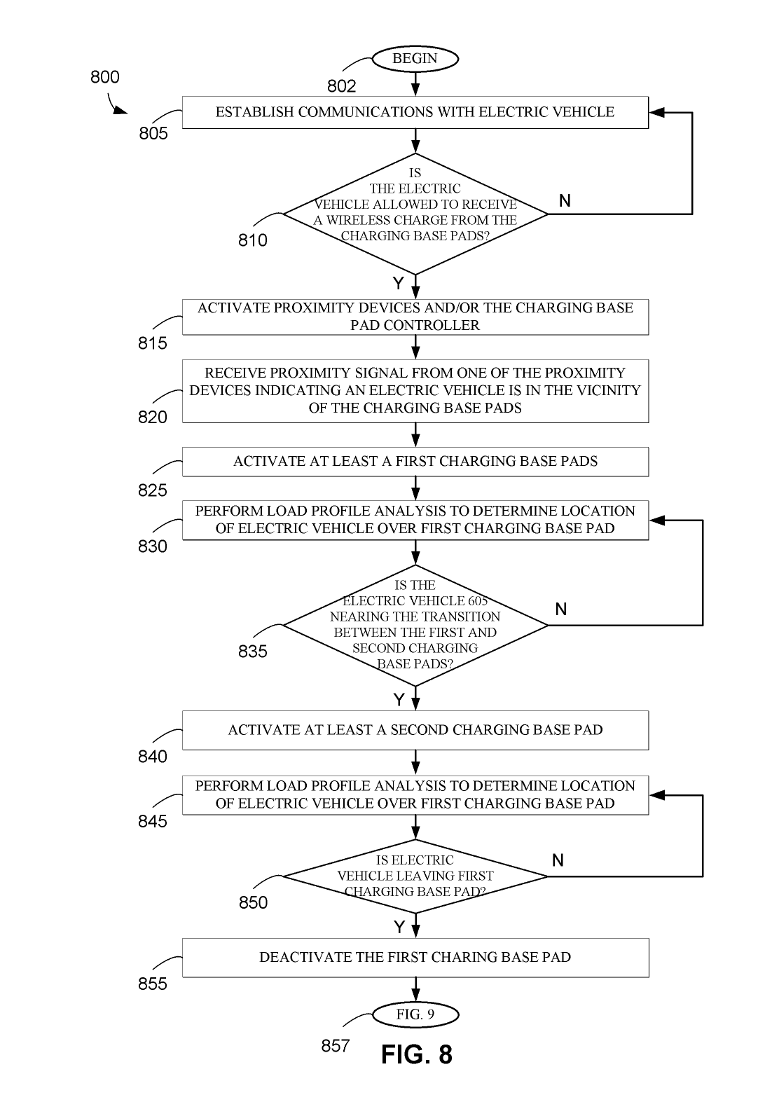

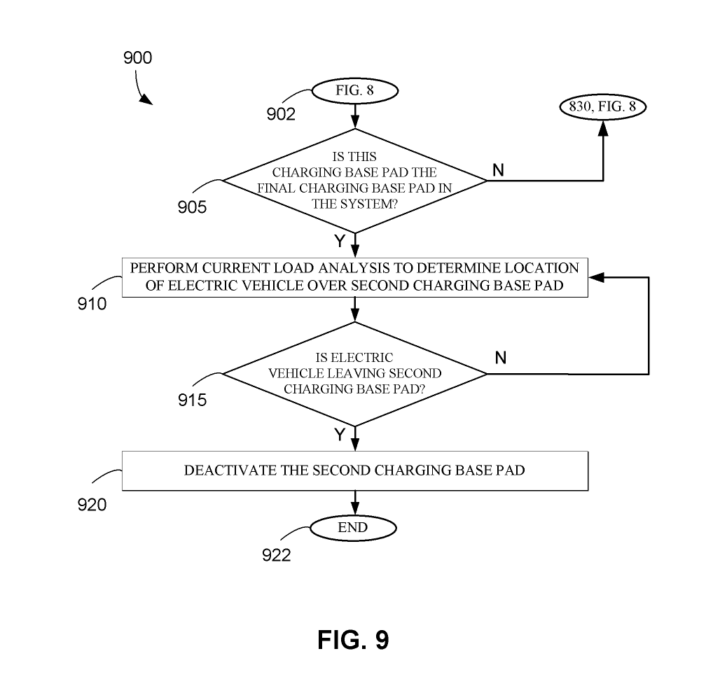

FIGS. 8 and 9 depict a flowchart of an exemplary method of charging an electric vehicle 605 according to the dynamic wireless charging system.

At block 805 of method 800, a device (such as EVSE 620 or the charging base pad controller 630) may communicate with an electric vehicle 605. This communication may comprise the initial communications to determine if the electric vehicle 605 is allowed to receive power from the dynamic wireless charging system 600. The communications from the electric vehicle 605 to the dynamic wireless charging system 600 may include its velocity, vector, and location (GPS/GNSS) of the electric vehicle.

At block 810, the EVSE 620 may determine whether the electric vehicle it is communicating with is allowed to receive a wireless charge from the charging base pads 615a-615d. If the electric vehicle 605 is determined to be allowed to receive a charge from the charging base pads 615a-615d, then the process moves to block 815. If the electric vehicle 605 is determined to not be allowed to receive a charge from the charging base pads, then the process returns to block 805.

If the system continues to block 815, the EVSE 620 may activate the proximity devices 610a-610c and/or the charging base pad controller 630. After the proximity devices 610a-610c are activated, the process may progress to block 820. At block 820, the proximity devices 610a-610c have been activated and are operating to detect an electric vehicle 605 that travels in the vicinity of the charging base pads 615a-615d. When one of the proximity devices 610a-610d detect the electric vehicle 605, the one of proximity devices 610a-610c sends a proximity signal to the EVSE 620.

The process continues to block 825, where at least one of the charging base pads 615a-615d may be activated in response to the EVSE 620 receiving a proximity signal from one of proximity devices 610a-610c. Then, the process reaches block 830 where load profile analysis is performed. The load profile analysis will allow the process to determine the location of the electric vehicle 605 as it is receiving wireless power from one of the charging base pads 615a-615d in order to control activating and deactivating charging base pad 615a-615d.

At block 835, the process determines, using the load profile analysis of block 830, if the electric vehicle 605 is nearing the transition between the charging base pads 615a and 615b. If the electric vehicle 605 is nearing the transition, then the process moves to block 840. If the electric vehicle 605 is not nearing the transition as determined in block 835 (e.g., if the load is at a determined threshold), then the process goes back to block 830 to determine the electric vehicle 605 location using load profile analysis. In some embodiments, the point of transition may be determined by a threshold load on the charging base pad(s) 615.

At block 840, the EVSE 620 may activate the second charging base pad 615b if block 835 determines the electric vehicle was nearing the transition. Then the process proceeds to block 845, where the process again determines the electric vehicle 605 position using load profile analysis. After this determination, the process proceeds to block 850 to determine if the load on the first charging base pad 615a is below a second threshold. If the load is below the second threshold, then the process proceeds to block 855. The load being below the second threshold level may indicate the electric vehicle 605 is leaving the area above the charging base pad 615a. If the load is not below the threshold, then the process repeats the block 845 to determine the load of the electric vehicle 605 and thus its position above the first charging base pad 615a.

Once the process reaches block 855, the process terminates the first charging base pad 615a due to the second threshold being reached, and the process proceeds to FIG. 9 and block 905. At block 905, the process determines if the second charging base pad 615b is the final charging base pad in the dynamic wireless charging system 600. If it is, then the process proceeds to the block 910. If it is not, then the process proceeds to block 830 with the second charging base pad 615 becoming the first charging base pad 615 for purposes of the process 800, and the process proceeds through the remaining blocks of process 800 until reaching the final charging pad in the system at block 905. At block 910, the process determines the current location on the second charging base pad 615b and proceeds to block 915. At block 915, the process determines whether the load from block 910 is below a threshold. The load falling below this threshold may indicate the electric vehicle 605 is nearing the edge of the charging base pad 615b. If the load is below a threshold, then the process proceeds to block 920; if it is not, then the process repeats at block 910. At block 920, the process deactivates the second charging base pad 615b in response to the load falling below the threshold, and the process terminates.

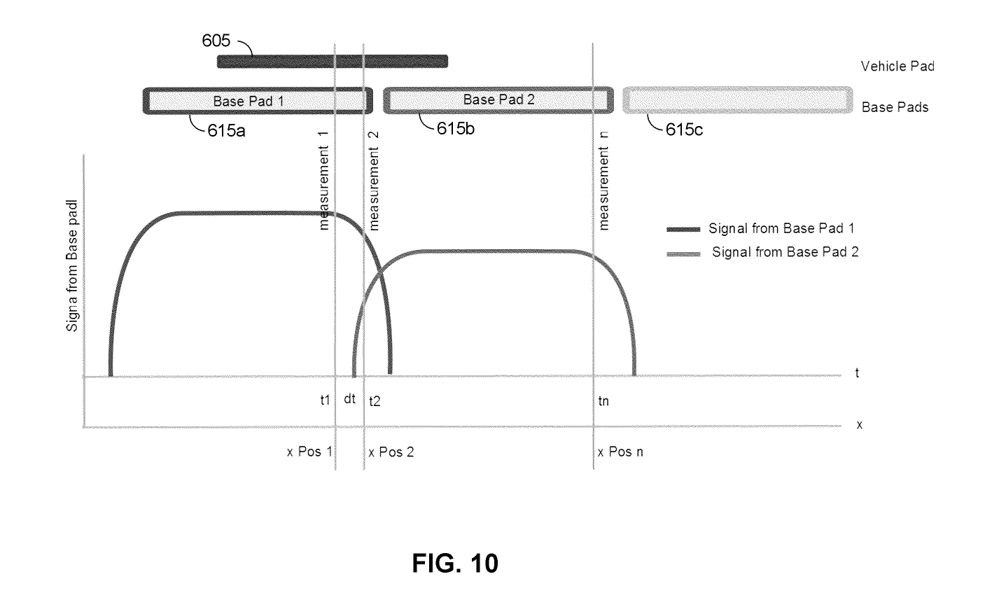

FIG. 10 depicts a graph of the loads of an electric vehicle 605 on two charging base pads 615 (e.g., charging base pads 615a and 615b). The x-axis of the graph is the time (t) (from left to right across the page, zero being on the left of the page), while the y-axis depicts the load signal from the charging base pad (depicted going up the page, starting with zero being on the bottom). Along the top of the chart is a visual guide of the electric vehicle 605 power receiving pad 606 position in relation to the charging base pads 615a-615d as the electric vehicle 605 travels above the charging base pads 615a-615d during the time (t) of the x-axis.

As the electric vehicle 605 and power receiving pad 606 travel over the charging base pad 615a, the load signal rises from zero as they enter the wireless field 635a (not shown in this figure) generated by charging base pad 615a. Then, the load rises to a maximum load, and begins decreasing as the electric vehicle 605 and power receiving pad 606 exit the wireless field 635a and enter the wireless field 635b (not shown in this figure) generated by charging base pad 615b. At time t1, the electric vehicle 605 and power receiving pad 606 are only within the wireless field 635a generated by charging base pad 615a. Thus, the graph shows the load on charging base pad 615a to be at its highest and there being no load on the charging base pad 615b. However, at time t2, the electric vehicle 605 and power receiving pad 606 have entered the wireless field 635b generated by charging base pad 615b. At time t2, the load on the charging base pad 615b is rising towards its maximum level, while the load on the charging base pad 615a is dropping toward zero. This process repeats for successive transitions between subsequent charging base pads until the final charging base pad is passed. In some embodiments, the load profile analysis described above may be used to determine a position and a speed and/or vector of an electric vehicle. The position and speed and/or vector determinations may be used to schedule the activation of subsequent charging base pads a distance down the roadway 625. In some embodiments, additional charging base pads may be used to verify the scheduling of the subsequent base pads to ensure the scheduling is accurate and updating the scheduling as necessary. In an alternate embodiment, the load profile analysis may be used to activate adjacent charging base pads 615 immediately as opposed to scheduling activations.

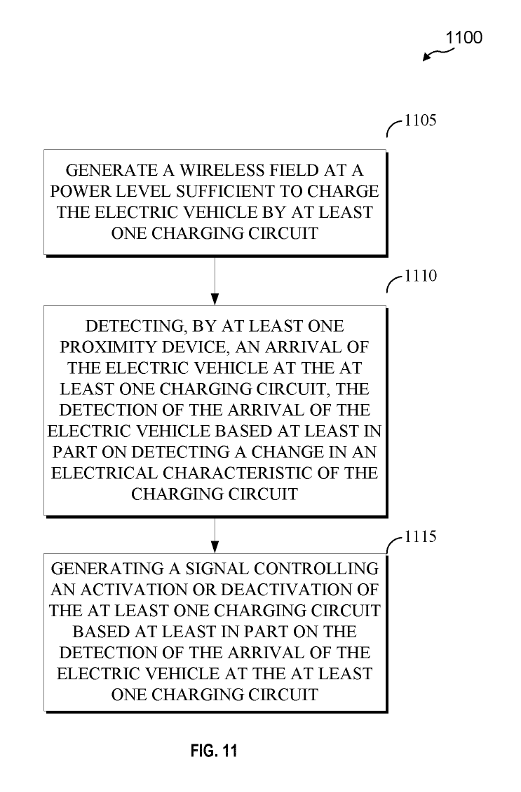

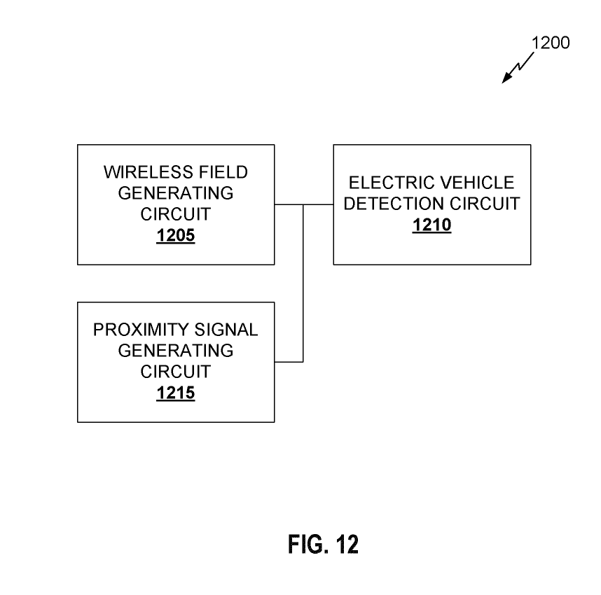

FIG. 11 represents a flowchart of a method for wirelessly charging an electric vehicle. In an embodiment, the dynamic wireless charging system 600 may perform the method 1100. In another embodiment, the EVSE 620 may perform the method 1100. In some other embodiments, the various blocks of method 1100 may be performed by one or more components of the dynamic wireless charging system 600. In block 1105, the dynamic wireless charging system 600, the EVSE 620, or a component of the dynamic wireless charging system 600 (e.g., the charging base pad controller 630) generates a wireless field at a power level sufficient to charge the electric vehicle 605 by at least one charging base pad 615 (charging circuit). The wireless field may be used to wireless transmit power from the charging base pad 615 to a receiving pad 606 on the electric vehicle 605.

At block 1110, the dynamic wireless charging system 600 may detect an arrival of the electric vehicle 605 at the at least one charging pad 615, wherein the detection of the arrival of the electric vehicle 605 at the at least one charging base pad 615 is determined based at least in part on a change in an electrical characteristic of the charging base pad 615. In some other embodiments, the detection of the electric vehicle 605 at the at least one charging pad 615 may be performed by a proximity device, configured to generate a signal to the dynamic wireless charging system 600 when the electric vehicle 605 is within sensing range of the proximity device. In other embodiments, detecting the arrival of the electric vehicle 605 at the charging base pads 615 may be performed by the charging base pad 615, wherein the change of the electrical characteristic of the charging base pad 615 may be sufficient for the system to determine the electric vehicle 605 is within range of the dynamic wireless charging system 600. Furthermore, the change of the electrical characteristic of the charging base pad 615 as the electric vehicle 605 travels above the charging base pad 615 may allow the dynamic wireless charging system 600 to track the position of the electric vehicle 605 in relation to the charging base pads 615 as the electric vehicle 605 travels above the charging base pads 615.

At block 1115, the dynamic wireless charging system 600 may generate a signal controlling an activation or a deactivation of the at least one charging base pad 615 based at least in part on the detection of the arrival of the electric vehicle 605 at the at least one charging base pad 615. In some embodiments, the generated proximity signal may be used to activate the charging functions of the one or more charging base pads 615 located at or near the proximity device. In some other embodiments, the proximity signal may be used to begin tracking the location of the electric vehicle 605 above the charging base pads 615.

FIG. 12 is a functional block diagram of a dynamic wireless charging system 600 that may be employed as depicted in FIG. 1. Those skilled in the art will appreciate that a dynamic wireless charging system 600 may have more components than the simplified wireless dynamic charging system 1200 shown in FIG. 12. The dynamic wireless charging system 1200 shown includes only those components useful for describing some prominent features of implementations within the scope of the claims. The dynamic wireless charging system 1200 may include a wireless field generating circuit 1205, an electric vehicle detection circuit 1210, and a proximity signal generating circuit 1215.

In some aspects, one or more of the wireless field generating circuit 1205, the electric vehicle detection circuit 1210, and/or the proximity signal generating circuit 1215 may be implemented within one or more of the EVSE 620, the charging base pad controller 630, or any other single component within the dynamic wireless charging system 600 discussed above.

In some implementations, the wireless field generating circuit 1205 may be configured to perform one or more of the functions discussed above with respect to block 1105. The wireless field generating circuit 1205 may include one or more of a charging base pad 615, a charging base pad controller 630/724, or the charging base pad driver 726. In some implementations, means for generating the wireless field and/or means for wireless transmitting power may include the wireless field generating circuit 1205.

In some implementations, the electric vehicle detection circuit 1210 may be configured to perform one or more functions discussed above with respect to block 1110. The electric vehicle detection circuit 1210 may include one or more of a proximity sensor 610, the charging base pad controller 630, a charging base pad 615, the EVSE 620, the antenna 734, the position circuit 730, the load circuit 728, or the communications circuit 732. In some implementations, means for detecting an electric vehicle, and/or means for detecting the presence of an electric vehicle, and/or means for determining an electric vehicle is within range of the charging base pads 615 may include the electric vehicle detection circuit 1210.

In some implementations, the proximity signal generating circuit 1215 may be configured to perform one or more functions discussed above with respect to block 1115. The proximity signal generating circuit 1215 may include one or more of a charging base pad 615, the charging base pad controller 630, the EVSE 620, the proximity device 610, the position circuit 730, the charging base pad driver 726, or the antenna 734. In some implementations, means for generating a proximity signal and means for generating a signal indicating the presence of an electric vehicle may include the proximity signal generating circuit 1215.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the embodiments of the invention.

The various illustrative blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media. The processor and the storage medium may reside in an ASIC.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

Various modifications of the above described embodiments will be readily apparent, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus for wirelessly charging an electric vehicle, comprising:
at least one charging circuit configured to generate a wireless field at a power level sufficient to charge the electric vehicle;
at least one proximity device configured to generate a proximity signal upon detecting an arrival of the electric vehicle at the at least one charging circuit, the detecting of the arrival based at least in part on detecting a change in an electrical characteristic of the at least one charging circuit, the change based on a change in distance of the electric vehicle from the at least one charging circuit; and
a processor configured to generate a signal controlling an activation or deactivation of the at least one charging circuit in response to receiving the proximity signal from the at least one proximity device.

2. The apparatus of claim 1, wherein the processor is configured to receive, from the electric vehicle, information about at least one of a location, or a velocity, or a direction vector of the electric vehicle relative to a predetermined location, or any combination thereof.

3. The apparatus of claim 1, wherein the at least one proximity device is configured to measure and communicate to the processor the change in the electrical characteristic of the at least one charging circuit.

4. The apparatus of claim 1, wherein the processor is further configured to determine a position of and a direction of travel of the electric vehicle, and is further configured to activate at least one subsequent charging circuit in front of the position of and along the direction of travel of the electric vehicle.

5. The apparatus of claim 1, wherein the processor is configured to determine an arrival of the electric vehicle at the at least one charging circuit if the change in the electrical characteristic of the at least one charging circuit indicates a value above a predetermined threshold amount.

6. The apparatus of claim 1, wherein the processor is further configured to generate a signal causing deactivation of the at least one charging circuit based upon detecting that the change in the electrical characteristic of the at least one charging circuit indicates a value below a predetermined threshold amount.

7. The apparatus of claim 1, wherein the processor is further configured to determine that the position of the electric vehicle is no longer over the at least one charging circuit upon detecting that the change in the electrical characteristic of the at least one charging circuit indicates a value below a predetermined threshold current level.

8. The apparatus of claim 1, wherein the at least one charging circuit is configured to generate a magnetic field and inductively transfer power to a receive circuit in the electric vehicle.

9. The apparatus of claim 1, wherein the electrical characteristic comprises a current draw on the at least one charging circuit, wherein a level of the current draw on the at least one charging circuit corresponds to a position of the electric vehicle in relation to the at least one charging circuit.

10. The apparatus of claim 1, wherein the change in the electrical characteristic is indicative of a change in load presented to the at least one charging circuit that changes based on proximity of the electric vehicle to the at least one charging circuit as the electric vehicle moves along a roadway.

11. A method for wirelessly charging an electric vehicle, comprising:
generating a wireless field at a power level sufficient to charge the electric vehicle by at least one charging circuit;
detecting, by at least one proximity device, an arrival of the electric vehicle at the at least one charging circuit, the detecting of the arrival of the electric vehicle based at least in part on detecting a change in an electrical characteristic of the at least one charging circuit, the change based on a change in distance of the electric vehicle from the at least one charging circuit;
generating a signal controlling an activation or deactivation of the at least one charging circuit based at least in part on the detection of the arrival of the electric vehicle at the at least one charging circuit.

12. The method of claim 11, further comprising receiving, from the electric vehicle, information about at least one of a location, or a velocity, or a direction vector of the electric vehicle relative to a predetermined location, or any combination thereof.

13. The method of claim 11, further comprising measuring by the proximity device, the change in the electrical characteristic of the at least one charging circuit.

14. The method of claim 11, further comprising determining a position of and a direction of travel of the electric vehicle; and
activating at least one subsequent charging circuit in front of the position of and along the direction of travel of the electric vehicle.

15. The method of claim 11, further comprising determining an arrival of the electric vehicle at the at least one charging circuit if the change in the electrical characteristic of the at least one charging circuit exceeds a predetermined threshold amount.

16. The method of claim 11, further comprising generating a signal causing deactivation of the at least one charging circuit based upon detecting that the change in the electrical characteristic of the at least one charging circuit falls below a predetermined threshold amount.

17. The method of claim 11, further comprising determining that the position of the electric vehicle is no longer over the at least one charging circuit based on detecting that the change in the electrical characteristic of the at least one charging circuit falls below a predetermined threshold amount.

18. The method of claim 11, wherein generating a wireless field at a power level sufficient to charge the electric vehicle by the at least one charging circuit comprises generating a magnetic field and inductively transferring power to a receive circuit in the electric vehicle.

19. The method of claim 11, wherein the electrical characteristic comprises a current draw on the at least one charging circuit, wherein a level of the current draw on the at least one charging circuit corresponds to a position of the electric vehicle in relation to the at least one charging circuit.

20. An apparatus for wirelessly charging an electric vehicle, comprising:
means for generating a wireless field at a power level sufficient to charge the electric vehicle;
means for detecting an arrival of the electric vehicle at the wireless field generating means, the detecting of the arrival of the electric vehicle based at least in part on detecting a change in an electrical characteristic of the wireless field generating means, the change based on a change in distance of the electric vehicle from the wireless field generating means; and
means for generating a signal controlling an activation or deactivation of the wireless field generating means based at least in part on the detection of the arrival of the electric vehicle at the at least one wireless field generating means.

21. The apparatus of claim 20, wherein the wireless field generating means comprises at least one charging circuit.

22. The system of claim 20, wherein the means for generating a proximity signal upon detecting an arrival of the electric vehicle at the wireless field generating means comprises at least one proximity device.

23. The system of claim 20, wherein the means for generating a signal controlling an activation or deactivation of the wireless field generating means in response to receiving the proximity signal from the means for generating a proximity signal comprises at least one processor.

24. The system of claim 20, further comprising means for receiving from the electric vehicle information about at least one of a location, or a velocity, or a direction vector of the electric vehicle relative to a predetermined location, or any combination thereof.

25. The system of claim 20, wherein the means for generating a signal controlling an activation or deactivation of the wireless field generating means in response to generating the proximity signal further comprises means for measuring the change in an electrical characteristic of the wireless field generating means.

26. The system of claim 20, further comprising:
means for determining a position of and a direction of travel of the electric vehicle; and
means for activating the wireless field generating means in front of the position and along the direction of travel of the electric vehicle.

27. The system of claim 20, further comprising means for determining an arrival of the electric vehicle at the wireless field generating means if the change in an electrical characteristic of the wireless field generating means exceeds a predetermined threshold amount.

28. The system of claim 20, further comprising means for generating a signal causing deactivation of the wireless field generating means upon detecting that the change in an electrical characteristic of the wireless field generating means falls below a predetermined threshold amount.

29. The system of claim 20, further comprising means for determining that the position of the electric vehicle is no longer over the wireless field generating means upon detecting that the change in an electrical characteristic of the wireless field generating means falls below a predetermined threshold amount.

30. The system of claim 20, wherein the wireless field generating means comprises means for generating a magnetic field and inductively transferring power to a receive circuit in the electric vehicle.
